(19) United States
(12) Patent Application Publication
(10) Pub. No.: US 2017/0341988 A1
(43) Pub. Date: Nov. 30, 2017

(54) SYSTEM AND METHOD FOR DISPOSING CARBON DIOXIDE

(71) Applicant: MACH IV, L.L.C., Dallas, TX (US)

(72) Inventors: Charles David Welker, Dallas, TX (US); Douglas James Sprague, Airdrie (CA)

(73) Assignee: MACH IV, L.L.C., Dallas, TX (US)

(21) Appl. No.: 15/605,264

(22) Filed: May 25, 2017

Related U.S. Application Data
(60) Provisional application No. 62/341,611, filed on May 25, 2016.

(51) Int. Cl. C04B 38/10; C04B 18/02; C04B 24/24; C04B 28/04; B28C 5/38; C04B 14/06; C09K 21/14; C04B 103/30; C04B 103/42; C04B 111/28; E04B 1/94

(52) U.S. Cl. CPC C04B 38/103; C04B 14/06; C04B 18/02; C04B 24/24; C04B 28/04; C09K 21/14; B28C 5/388; C04B 2103/42; C04B 2111/28; E04B 1/944; E04B 2103/02; C04B 2103/302

(57) ABSTRACT

A system and method for disposing carbon dioxide is disclosed. The system includes a foam generator that generates a plurality of disposable foam vessels from a polymer based solution mixed with water and captured carbon dioxide from the atmosphere. The plurality of disposable foam vessels contains an amount of carbon dioxide. The plurality of disposable foam vessels is mixed in a cementitious material with a set of mixers. In a preferred embodiment, the set of mixers is a concrete mixing plant. During the curing process of the cementitious material the plurality of disposable foam vessels dissipates allowing for a timely release of CO₂ to chemically react with the surrounding cementitious material. This irreversible chemistry change permanently disposes of the carbon dioxide.

### CROSS-REFERENCE TO RELATED APPLICATION

This application claims priority to U.S. Provisional Application No. 62/341,611, filed May 25, 2016. This patent application is incorporated by reference herein in its entirety to provide continuity of disclosure.

### FIELD OF THE INVENTION

The present invention is related to systems and methods for the treatment of greenhouse gases. In particular, the present invention is related to systems and methods for the compartmentalization, transport, and disposal of excess carbon dioxide from the atmosphere.

### BACKGROUND OF THE INVENTION

Greenhouse gas levels are reaching levels that challenge the sustainability of our planet. A primary component of greenhouse gases is carbon dioxide (CO₂) which includes on average seventy-seven (77) percent of greenhouse gases. For most of the past one million years, greenhouse gas levels have remained below three hundred (300) parts per million (ppm). Technological advancements and global population growth patterns in the past fifty (50) years have driven greenhouse gas levels to 335 ppm in 1980, and to an astounding 400 ppm in 2013. A present understanding of a balanced ecosystem requires less than a 3 degree Celsius temperature change globally. Therefore, greenhouse gas levels must remain below 450 ppm or humans may undergo global changes that challenge the norm of human existence as currently understood. In 2013, the estimated worldwide production of CO₂ was 39.8 billion tons. Numerous industries have been accused of contributing to the rising the levels of greenhouse gases, including the concrete industry.

Concrete applications are as numerous and diverse as restaurants within a large city. They range from infrastructure, such as roads and bridges, to precast buildings, components for housing, playgrounds, chemical plants and soil stabilization applications. The infrastructure segment, such as roads and bridges, in the United States comprise over 50% of the concrete usage today. This infrastructure segment is typically regulated and, therefore highly influenced by several governing bodies including the American Concrete Institute, state government agencies (e.g. city, state and Federal departments of transportation, and tollway authorities) as well as the Federal Highway Administration (FHWA). These agencies look to set requirements that have inherent safety considerations for placement and utilization of concrete for infrastructure purposes. As such, where or when agencies are engaged, these agencies look to specify and monitor key properties of concrete, such as strength (compressive and flexural) and sustainability (durability). Today, typical design dictates higher cement usage to generate desired performance properties, which results in a higher carbon footprint.

Concrete is the second most consumed product in the world next to water. The primary constituent of this consumption is Portland cement, which has a low carbon footprint relative to other industrial products. However, the size of the industry dictates a significant impact on the overall production of greenhouse gases. For example, in 2005 the concrete and cement industry was responsible for roughly 5-7% or 1.5 billion tons (bt) of the greenhouse gas emissions. The United States government has proposed greenhouse gas reduction targets in the range of approximately 17 percent by 2020 and 26 to 28 percent by 2025. These reductions in greenhouse gases must be in place by 2030 as per the International Energy Agency for the sustainability of our planet. In addition, the advancement of the middle class in areas such as China and India impose an additional demand for concrete and other cementitious products.

CO₂ has a significant positive impact on the above mentioned key design properties of strength and sustainability. However, as current best-practice know-how stands, when CO₂ is introduced into the concrete manufacturing/mixing process, rapid adsorption of CO₂ causes development of carbonic acid and excess heat, which leads to flash setting and less than desirable end product properties.

Further, the production of cement, the primary constituent of concrete, utilizes a process where products such as limestone and sand are heated to approximately 1450 Celsius. Upon cooling, this material is then ground and gypsum is added to control the rate of (concrete) setting. This deliberate process generates CO₂ in the following manner: 1) CO₂ is released when the limestone is heated; 2) CO₂ is generated by burning fossil fuels to heat the kiln; and, 3) CO₂ is also generated to create the electricity in the production process and direct fuel consumed for transportation and hauling of materials.

Today's current industry practices limit the use of CO₂ with concrete applications primarily because in pre-cast concrete, for example, CO₂ can only be introduced to the concrete after the concrete is made and placed. Current cast-in-place applications (ready mix, on site) do not utilize sequestered CO₂ injection since the CO₂ reacts chemically to form carbonic acid which lowers the pH of the concrete. Lowering the pH negatively affects the final properties of the concrete product.

Therefore, there is a need in the art for a system and method for disposing of carbon dioxide in a predictable, controlled, and repeatable manner that permanently removes carbon dioxide from the atmosphere.

### SUMMARY

A system and method for disposing carbon dioxide is disclosed. The system includes a foam generator that generates a plurality of disposable foam vessels from a polymer based solution mixed with water and captured carbon dioxide from the atmosphere. The plurality of disposable foam vessels contains an amount of carbon dioxide. The plurality of disposable foam vessels is mixed in a cementitious material with a set of mixers. In a preferred embodiment, the set of mixers is a concrete mixing plant. During the curing process of the cementitious material the plurality of disposable foam vessels dissipates allowing for a timely release of CO₂ to chemically react with the surrounding cementitious material. This irreversible chemistry change permanently disposes of the carbon dioxide.

### BRIEF DESCRIPTION OF THE DRAWINGS

The embodiments disclosed below will described with reference to the following drawings.

FIG. 1A is a plan view of an apparatus for generating a plurality of disposable CO₂ foam vessels of a preferred embodiment.

FIG. 1B is a plan view of a system for disposing the plurality of disposable CO₂ foam vessels of a preferred embodiment.

FIG. 2 is a detailed schematic view of a disposable CO₂ foam vessel disposed in a cementitious material of a preferred embodiment.

FIG. 3 is a detailed schematic view of a disposed CO₂ foam vessel in a cementitious material of a preferred embodiment.

FIG. 4 is a detailed schematic view of disposed CO₂ in a cementitious material of a preferred embodiment.

FIG. 5 is a flowchart of a method of disposing CO₂ of a preferred embodiment.

FIG. 6 is a detail view of a void system of a control sample using compressed air in the disposable foam vessels of a preferred embodiment.

FIG. 7 is a detail view of a void system of a test sample using a first level of CO₂ in the disposable foam vessels of a preferred embodiment.

FIG. 8 is a detail view of a void system of a test sample using a second level of CO₂ in the disposable foam vessels of a preferred embodiment.

FIG. 9 is a detail photo of a control sample using compressed air in the disposable foam vessels of a preferred embodiment.

FIG. 10 is detail photo of a test sample of using a first level of CO₂ in the disposable foam vessels of a preferred embodiment.

FIG. 11 is a detail photo of a test sample of using a second level of CO₂ in the disposable foam vessels of a preferred embodiment.

FIG. 12A is a detail micrograph using plane-polarized light of set of voids created by the disposable foam vessels of compressed air of a preferred embodiment.

FIG. 12B is a detail micrograph using crossed-polarized light of set of voids created by the disposable foam vessels of compressed air of a preferred embodiment.

FIG. 13A is a detail micrograph using plane-polarized light of set of voids created by the disposable foam vessels of a first level of CO₂ of a preferred embodiment.

FIG. 13B is a detail micrograph using crossed-polarized light of set of voids created by the disposable foam vessels of a first level of CO₂ of a preferred embodiment.

FIG. 14A is a detail micrograph using plane-polarized light of set of voids created by the disposable foam vessels of a second level of CO₂ of a preferred embodiment.

FIG. 14B is a detail micrograph using crossed-polarized light of set of voids created by the disposable foam vessels of a second level of CO₂ of a preferred embodiment.

FIG. 15 is a section view of a steel beam member surrounded by the disclosed embodiments.

### DETAILED DESCRIPTION

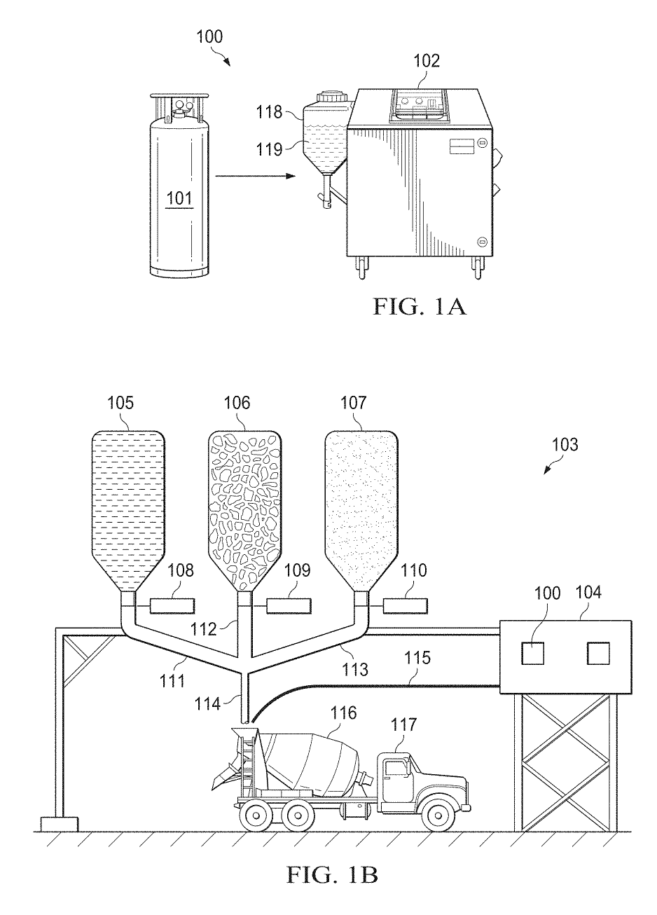

Referring to FIG. 1A, entrainment system 100 includes carbon dioxide supply 101 connected to foam generator 102. Foam generator 102 includes solution supply 118 containing gas entrainment solution 119. Gas entrainment solution 119 is delivered at a predetermined flow rate. Carbon dioxide supply 101 delivers carbon dioxide at a predetermined rate and pressure into foam generator 102. A water supply is connected to foam generator 102 and is supplied at a predetermined temperature and rate. Foam generator 102 generates a plurality of disposable foam vessels from carbon dioxide supply 101, gas entrainment solution 119, and the water supply to compartmentalize the carbon dioxide.

In a preferred embodiment, no minimum percentage of carbon dioxide is required. The carbon dioxide can be mixed with other gases such as compressed air or nitrogen.

In a preferred embodiment, foam generator 102 is the Miracon® ToughAir® Air Entrainment System available from Miracon Technologies, LLC of Richardson, Tex. Any foam generator known in the art may be employed.

In a preferred embodiment, gas entrainment solution 119 is a polymer based solution. Any type of air entrainment solution known in the art may be employed.

An exemplary formula for the gas entrainment solution is provided in Table 1 below.

TABLE 1

| | | Amount Ranges |
|---|---|---|
| | | (in approximate |
| | Molecular | percentage |
| Component | Formula | by weight) |
| Water | H₂O | 91.3% to 82.0% |
| N-Dodecyl-B- | C₁₈H₃₃NNa₂O₄ | 0.04% to 3.0% |
| Iminodipropionic Acid | | |
| N,N-BIS(2-HYDROXY- | C₁₆H₃₃NO₃ | 0.08% to 5.0% |
| ETHYL)DODECANAMIDE | | |
| Oligomer of Ethylene Oxide | C₂ₙH₄ₙ₊₂Oₙ₊₁ | 2.0% to 10.0% |

In some embodiments, additives may be added to the water supply and/or gas entrainment solution 119 to alter the structure of the plurality of disposable foam vessels.

Referring to FIG. 1B in a preferred embodiment, concrete is employed as a disposal unit for the plurality of disposable foam vessels. Any type of cementitious material known in the art may be employed as the disposal unit, including gypsum.

In a preferred embodiment, air entrainment system 100 is housed in station 104 of concrete plant 103. Concrete plant 103 includes hoppers 105, 106, and 107. Hopper 105 is connected to gate 108. Gate 108 is connected to chute 111. Hopper 106 is connected to gate 109. Gate 109 is connected to chute 112. Hopper 107 is connected to gate 110. Gate 110 is connected to chute 113. Each of chutes 111, 112, and 113 is connected to outlet 114. A set of controllers is connected to each of gates 108, 109, and 110. Hoppers 105, 106, and 107 store materials such as cement, sand, rock and other aggregates, and supplemental cementitious materials, such as fly ash. Predetermined amounts of materials, including water, are controllably fed into mixer 116 of concrete truck 117. The generated plurality of disposable foam vessels is controllably sent through outlet 115 to mixer 116 to be mixed with the concrete.

In a preferred embodiment, the plurality of disposable foam vessels is mixed with the concrete as a foam in an amount ranging from approximately 2% to approximately 80% by volume of the entire concrete mix. The percentage by volume depends on the application of the concrete and the desired properties of the final concrete product. In some embodiments, the percentage of volume substitution by the plurality of disposable foam vessels is as much as approximately 80% by volume where the plurality of disposable foam vessels replaces other materials. For example, at approximately 80% by volume of the plurality of disposable foam vessels, the only remaining materials in the concrete mix would be cement and water. It will be appreciated by those skilled in the art that the extent, number, and combinations of suitable mix designs that may be employed are numerous.

It will be further appreciated by those skilled that numerous materials known in the art that can be added into a concrete mixture include without limitation: different types of cementitious materials including different types of cement, fly ash, slag; different types of rock materials including hard and/or dense rock, many different types of lightweight aggregate, or no rock or aggregate at all; different types of sand including find sands to coarse sands; and any admixtures and/or combinations of admixtures known in the art and any suitable range amounts of such admixtures and/or combinations of admixtures known in the art may be employed.

An exemplary concrete mix design is described in Table 2 below, which can be scaled to suit any desired need. Other suitable mix designs known in the art may employed.

TABLE 2

| | Amount |
|---|---|
| | (approximate |
| | percentage |
| Component | by volume) |
| Portland Cement - Type I/II | 11.1% |
| Water | 15.2% |
| #67 Rock | 34.0% |
| Concrete Sand | 31.3% |
| Gas Entrainment (Foam vessels) | 7.9% |
| High Range Water Reducer (preferably, Master | 0.01% |
| Builders MB7500, although any suitable high | |
| range water reducer known in the art may be | |
| employed) | |

In other embodiments, a pre-cast concrete plant is employed. Any mechanism known in the art to mix the plurality of disposable foam vessels with concrete may be employed.

In a preferred embodiment, the plurality of disposable foam vessels is used with existing mix designs, products and infrastructure, including mix designs for precast and transit mixtures—to be cast in place.

In a preferred embodiment, the plurality of disposable foam vessels is designed to dispose of carbon dioxide in any wet cast concrete application, with a polymer based air entrainment solution. As will be further described below, the controlled release of carbon dioxide into wet cast concrete enables the carbon dioxide to be consumed in the chemical reaction. The cement acts as a natural sink for the carbon dioxide. The carbon dioxide is compartmentalized, engages in the chemistry of the curing concrete mix, and permanently becomes part of the final product. As the carbon dioxide is released in a controlled, timely manner, the carbon dioxide is converted to calcium carbonate, resulting in enhanced properties of the concrete.

The disclosed embodiments allow for supplemental cementitious materials to be used as partial replacements of quantities of Portland cement which results lower amounts of Portland cement required. Supplemental cementitious materials have a calcium based chemistry similar to that of Portland cement. The reduction in the use of Portland cement lowers the carbon footprint of concrete. Applications of the disclosed embodiments range from bridge decks, buildings, playground materials, and soil stabilization.

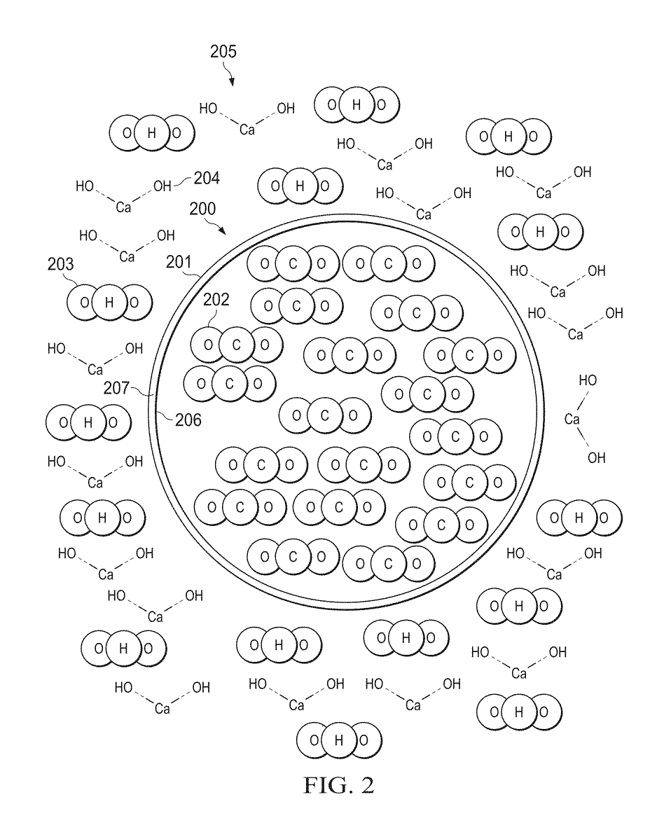

Referring to FIG. 2 by way of example, a disposable foam vessel of the plurality of disposable foam vessels will be further described. Disposable foam vessel 200 is in cementitious mixture 205. Cementitious mixture 205 is in a plastic state. Cementitious mixture 205 includes at least water 203 and calcium hydroxide 204. Disposable foam vessel 200 includes film surface 201 continuously surrounding carbon dioxide 202. Film surface 201 includes at least gas entrainment solution 206 and water 207. Film surface 201 delays the reaction of carbon dioxide 202 with cementitious mixture 205 by resisting dissipation until after a predetermined time period. The predetermined time period depends on the structure of film surface 201. The structure of film surface 201 may be modified by altering the compositions and amounts of gas entrainment solution 206, thereby altering the strength of film surface 201.

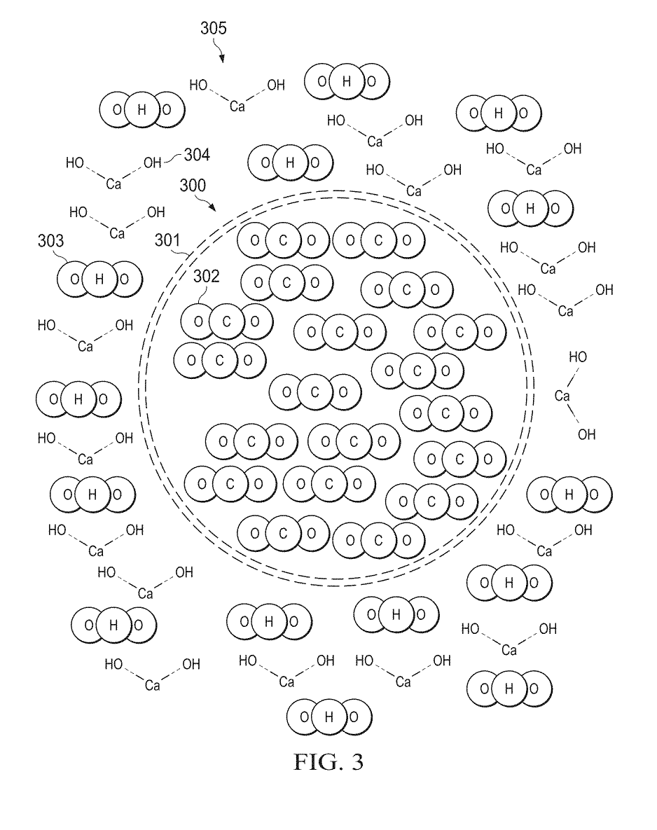

Referring to FIG. 3, after a predetermined time period, film surface 301 of disposable foam vessel 300 will dissipate and enable carbon dioxide 302 to react with calcium hydroxide 303 to form calcium carbonate (CaCO₃) in cementitious mixture 305. Calcium hydroxide 303 comprises approximately 25% to approximately 50% of the weight of the cement paste. The delay of the dissipation of disposable foam vessel 300 prevents carbon dioxide 302 from directly reacting with water 303 resulting in carbonic acid. The delay allows water 303 to first react with the calcium in cementitious material 305. Once carbon dioxide 302 is released due to the dissipation of film surface 301 of disposable foam vessel 300, carbon dioxide 302 will react with calcium hydroxide 304 to create calcium carbonate without creating carbonic acid.

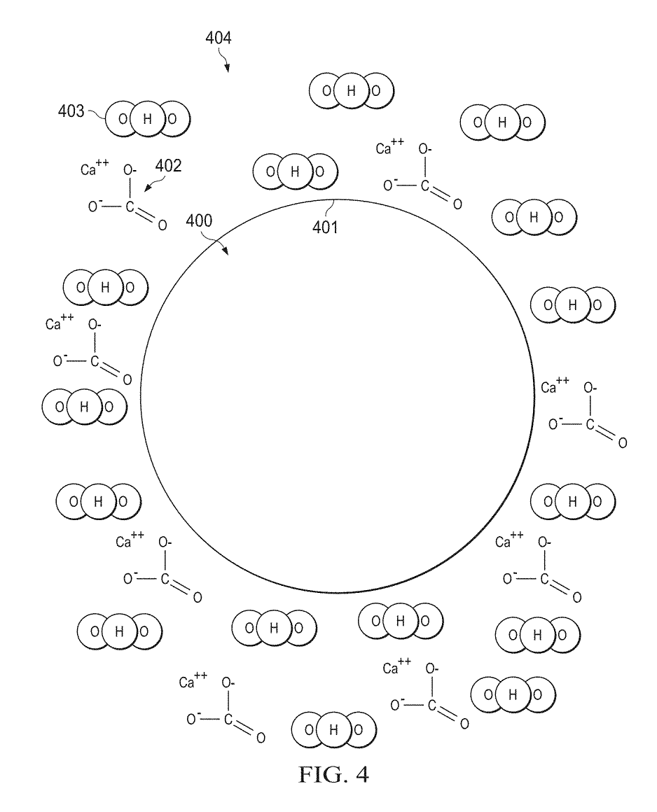

Referring to FIG. 4, void 400 includes perimeter 401 formed by the dissipation of the film surface of the disposable foam vessel and the formation of calcium carbonate 402 through a controlled at least partial curing from the released carbon dioxide in cementitious mixture 404 which further includes at least water 403. The formation of calcium carbonate 402 completes the disposal of the carbon dioxide transported into the cementitious material by the plurality of the disposable foam vessels. In this way, the carbon dioxide is now permanently unavailable as a greenhouse gas. Even after the cementitious mixture is cured, the carbon dioxide is completely and permanently disposed of even if the cured cementitious material is broken apart.

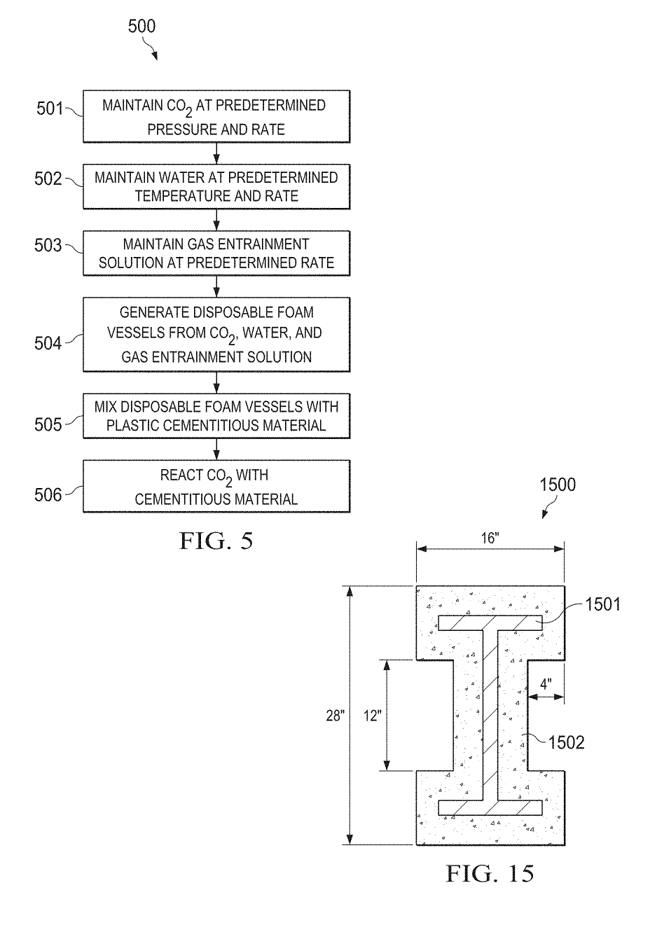

Referring to FIG. 5, method 500 for disposing carbon dioxide will be described. At step 501, the carbon dioxide is maintained at a predetermined pressure and flow rate. In a preferred embodiment, the predetermined pressure is in a range from approximately 60 psi to approximately 150 psi. In a preferred embodiment, the predetermined flow rate in a range from approximately 2 cfm to approximately 50 cfm. At step 502, water is maintained a predetermined temperature and flow rate. In a preferred embodiment, the predetermined temperature is in a range from approximately 35 degrees Fahrenheit to approximately 100 degrees Fahrenheit. In a preferred embodiment, the predetermined flow rate is in a range from approximately 0.02 gpm to approximately 10 gpm. In this step, any mechanisms known in the art for heating and/or cooling water may be may be employed, including heating jackets and/or coils, boilers, heat exchangers, refrigerants, compressors, and/or condensers. In this step, any mechanisms known in the art of increasing and/or decreasing liquid flow rates may be employed, including pumps, valves, and/or piping of varying diameters.

At step 503, a gas entrainment solution is maintained at a predetermined flow rate. In a preferred embodiment, the predetermined flow rate is in a range from approximately 0.02 gpm to approximately 10 gpm. In this step, any mechanisms known in the art of increasing and/or decreasing liquid flow rates may be employed, including pumps, valves, and/or piping of varying diameters.

At step 504, a plurality of disposable foam vessels is generated from the water, the carbon dioxide, and the gas entrainment solution.

At step 505, the plurality of disposable foam vessels is mixed with a cementitious material in a plastic state, preferably in a plastic concrete mixture. At step 506, the carbon dioxide reacts with the cementitious material in the concrete mixture after a predetermined time. In a preferred embodiment, the predetermined time is the time period required for the plurality of disposable foam vessels to dissipate. Other known means of delaying dissipation of the foam vessels or bubbles may be employed, including chemical additives to the cementitious material and/or the gas entrainment solution.

Tests Overview

A set of tests were performed to evaluate the efficacy of the disclosed embodiments. The tests included the fabrication of concrete specifications containing average loadings of carbon dioxide, 13.8% (Lo CO₂) and 18.1% (Hi CO₂) by volume, introduced into the concrete specimens utilizing the previously described disposable foam vessels, and a control average loading of 11% by volume of compressed laboratory air (Comp. Air). Each concrete specimen was fabricated using the same foaming agent and foam generator supplied by Miracon Technologies, LLC of Richardson, Tex.

The testing program characterized the physical and mechanical properties of the fabricated, cured concrete specimens. The specimens were evaluated petrographically to assess the impact of carbon dioxide addition into the concrete mixtures, and then compared to the control mixture made with compressed air. Observations were made as to desired properties, including mechanical strength, freeze-thaw resistance and drying shrinkage.

Test 1—Mechanical and Physical Evaluation

The properties of interest selected for this evaluation were mechanical (compressive) strength, freeze-thaw resistance, and length change. The selected properties were evaluated for Comp. Air, Hi CO₂ and Lo CO₂ over a sufficient period of time to study the early and short term effects of concrete carbonization on specimen durability.

The purpose of the Hi CO₂ (18.1%) test was to determine if significantly higher carbon dioxide loading rates had any recordable effect on early or later stage curing rates or if higher loading rates of carbon dioxide would produce a greater possibility or incidence of development of carbonic acid.

Generally, the results show that there was no recordable difference in rate of cure, nor was there any evidence of carbonic acid in the petrographic macro or microscopic analysis. The results of Test 1—Mechanical and Physical Evaluation of industry accepted test are shown below in Table 3, Table 4, and Table 5.

TABLE 3
ASTM C666, Standard Test Method for
Resistance of Concrete to Rapid Freezing and Thawing
Procedure A, Freezing and Thawing in Water (306 cycles)

| | Average Comp. | Average Lo | Average Hi |
|---|---|---|---|
| | Air (11%) | CO₂ (13.8%) | CO₂ (18.1%) |
| Length Change % | 0.012 | 0.013 | 0.012 |

TABLE 4
ASTM C 157 Drying Shrinkage

| | Average Comp. | Average Lo | Average Hi |
|---|---|---|---|
| | Air (11%) | CO₂ (13.8%) | CO₂ (18.1%) |
| Drying Shrinkage | −0.044 | −0.038 | −0.015 |

Referring to Table 4, a negative length change indicates shrinkage. Accordingly, a higher/greater negative number indicates a greater length change.

TABLE 5
ASTM C39 and AASHTO T 22
Standard Test Method for Compressive Strength
of Cylindrical Concrete Specimens (psi)

| | Average Comp. | Average Lo | Average Hi |
|---|---|---|---|
| Time | Air (11%) | CO₂ (13.8%) | CO₂ (18.1%) |
| 7 Days | 4650 | 4077 | 2160 |
| 28 Days | 5277 | 4603 | 2440 |
| 90 Days | 5777 | 4993 | 2830 |

An accepted concrete industry practice is that compressive strength will decrease by 5% to 6% for every 1% increase in air/gas. This practice applies to products of relatively close air void density. For example, where Average Comp-Air is 11% and Average Lo CO₂ is 13.8%, the industry accepted compressive strength decrease is calculated as follows:

Compressive Strength_{Industry}=(13.8%−11%)*5% Eq. 1

Compressive Strength_{Industry}=14%

Now, using the test samples, the tested compressive strength reduction is as follows:

$$Compressive {Strength}_{Tested} = \frac{( 5777 - 4993 )}{5777} \\ Compressive {Strength}_{Tested} = 13.6 \% \qquad Eq . 2$$

As can be seen by comparing the results of Eq. 1 and Eq. 2, the Average Lo CO₂ compressive strength is at least within the industry accepted compressive strength decrease.

Test 2—Petrographic Study of Concrete Specimens

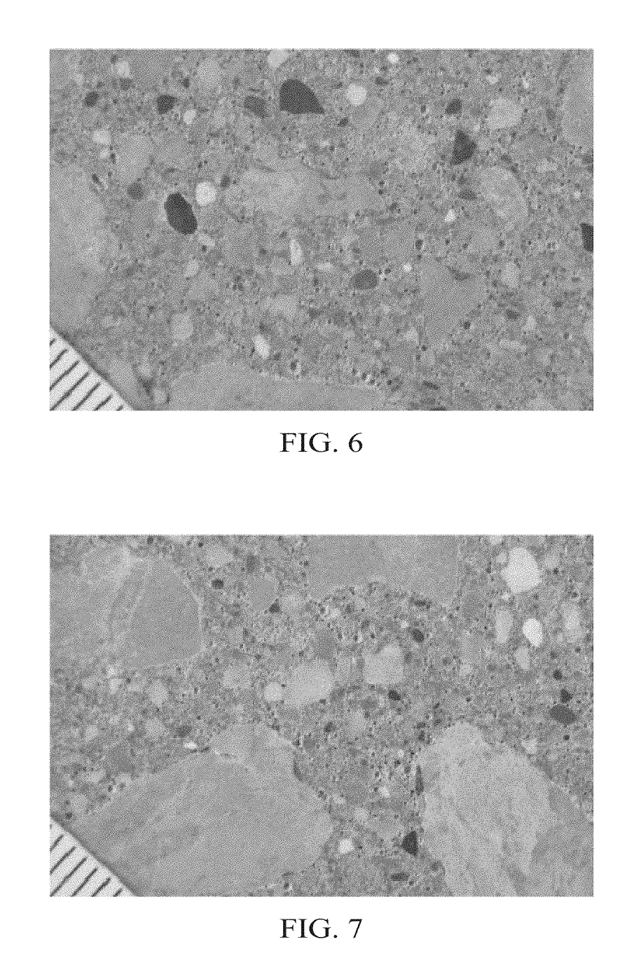

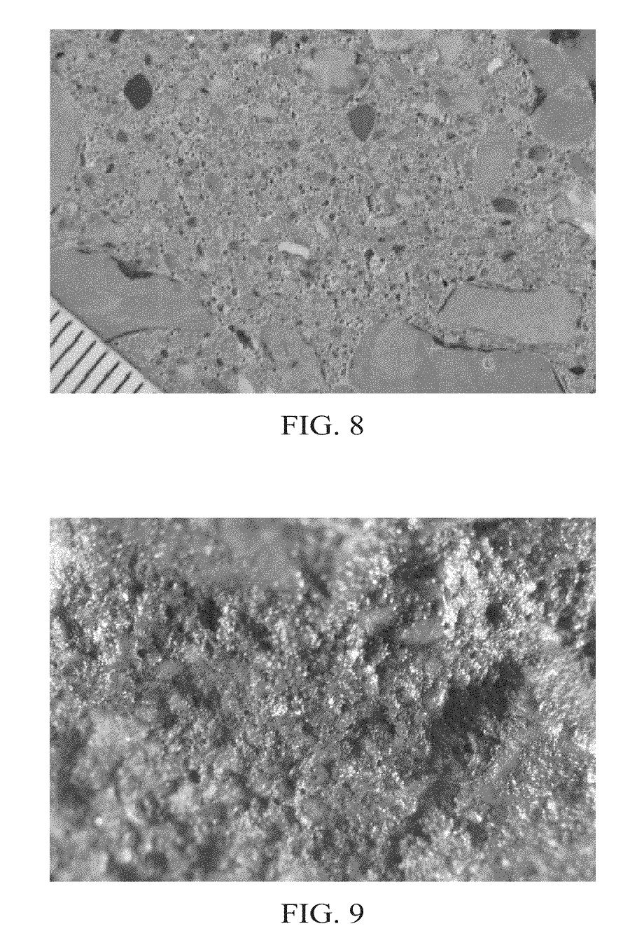

Each of the three concrete samples was microscopically evaluated to observe if any of the microstructures of the tested samples were affected by the addition of carbon dioxide. A thin section from each concrete specimen was prepared for examination with an optical microscope. The micrographs of the void system of the compressed air sample, the Lo CO₂ sample, and the Hi CO₂ samples are shown in FIG. 6, FIG. 7, and FIG. 8, respectively. Observations were noted that the intentional variation in total void content were as designed. No other noticeable differences were observed or noted in the microstructures in FIGS. 7 and 8 when compared to the control microstructure shown in FIG. 6.

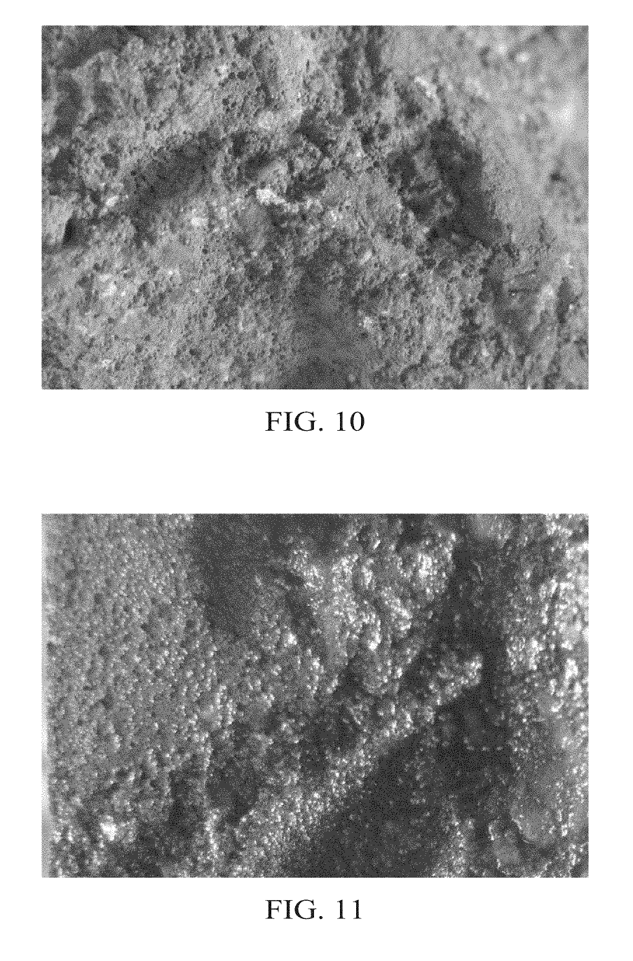

Referring to FIGS. 9, 10, and 11, carbonation on a macroscale was investigated through the application of phenolphthalein to the surface of the compressed air sample, the Lo CO₂ sample, and the Hi CO₂ sample, respectively. Micrographs depicting the microstructures of the compressed air sample, the Lo CO₂ sample, and the Hi CO₂ sample are shown respectively in FIGS. 9, 10, and 11. Phenolphthalein will turn the surface pink if the surface is uncarbonated. In contrast, if the surface is carbonated, the original color will remain. As can be seen, none of the tested samples, i.e., the Lo CO₂ sample, and the Hi CO₂ sample, exhibited any signs of carbonation.

Test 3—Carbonation of Concrete Paste

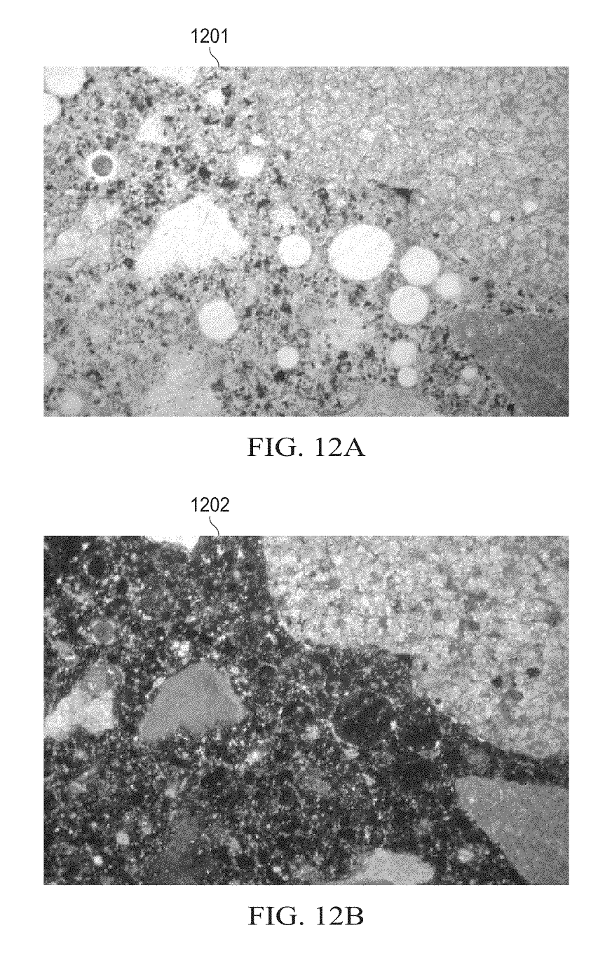

Referring to FIGS. 12A, 12B, 13A, 13B, 14A, and 14B, carbonation on a microscale was investigated by examining the paste surrounding the voids in the concrete samples. Thin sections of the compressed air sample, the Lo CO₂ sample, and the Hi CO₂ sample, respectively, were prepared for examination under a microscope. As can be seen, in general, no carbonated paste was observed in any of the concrete samples.

Referring to FIGS. 12A and 12B, sections 1201 and 1202 are different views of the same sample of the compressed air sample illuminated under plane-polarized light and cross-polarized light, respectively. The width of each view is approximately 0.78 mm. The bright-colored material in the paste includes calcium hydroxide crystals and a moderate amount of carbonate fines. No carbonate paste was observed.

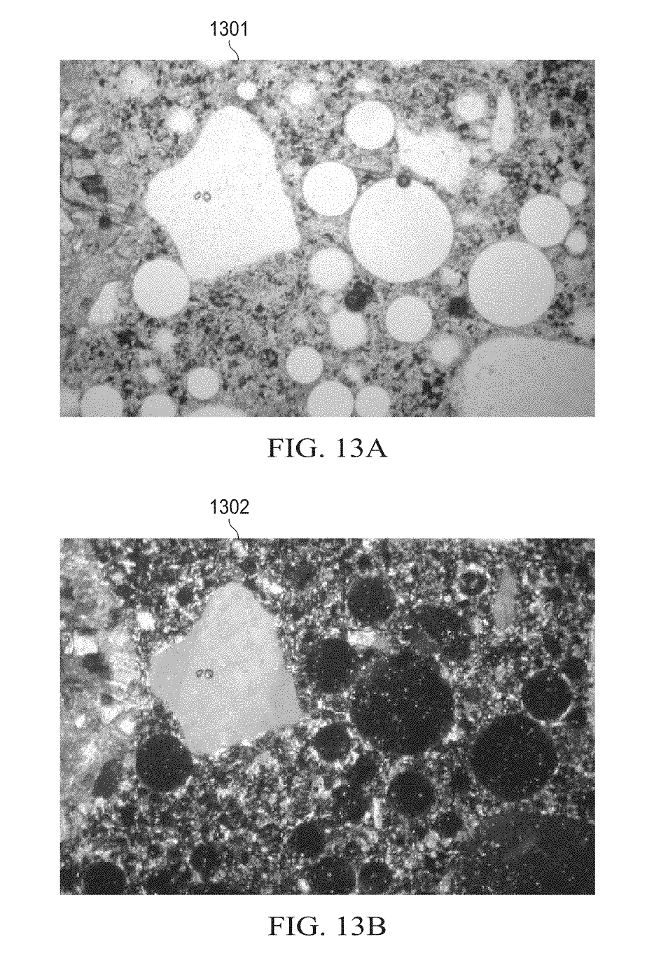

Referring to FIGS. 13A and 13B, sections 1301 and 1302 are different views of the same sample of the Lo CO₂ sample illuminated under plane-polarized light and cross-polarized light, respectively. The width of each view is approximately 0.78 mm. The bright-colored material in the paste includes calcium hydroxide crystals and a moderately high amount of carbonate fines. No carbonate paste was observed.

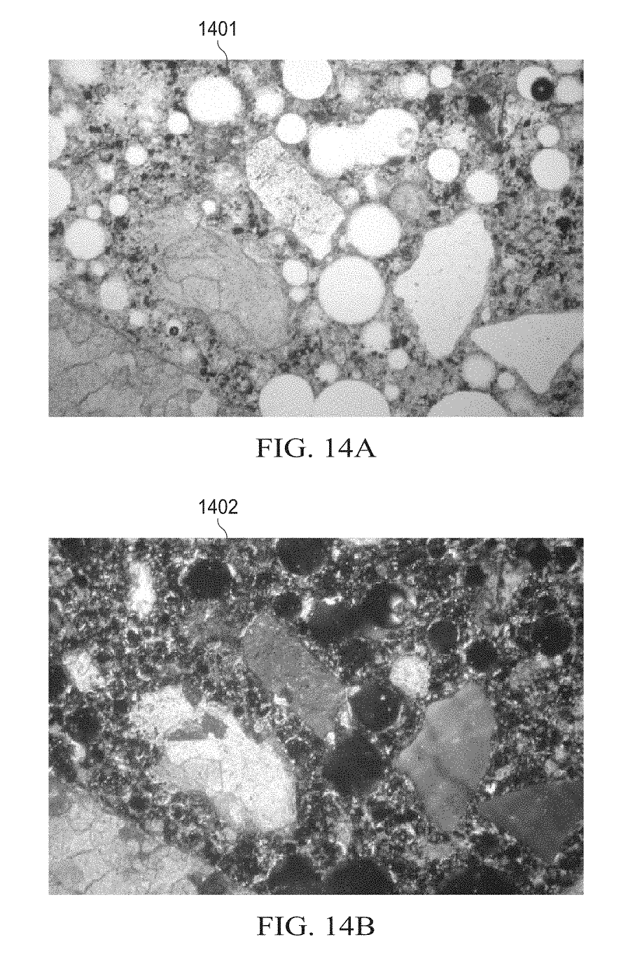

Referring to FIGS. 14A and 14B, sections 1401 and 1402 are different views of the same sample of the Hi CO₂ sample illuminated under plane-polarized light and cross-polarized light, respectively. The width of each view is approximately 0.78 mm. The bright-colored material in the paste includes calcium hydroxide crystals and a moderately high amount of carbonate fines. No carbonate paste was observed.

Test 4—Calculation of Internal Bubble Pressure for the Plurality of Foam Vessels

The test was performed using a custom-built cylindrical pressure chamber having an internal diameter of approximately 6.06 inches and a length of approximately 24 inches. The purpose of the test was to confirm the amount of pressure at which a foam vessel or bubble would collapse. The test methodology began by filling the pressure chamber from the top with foam. Ensure good quality foam is flowing through the chamber and out the exhaust port at the bottom of the chamber. Once the chamber is full of foam, the foam supply is shut off and the valve at the chamber closed. The exhaust port valve at the bottom of the chamber is closed. Utilizing a regulator to control the pressure level, slowly increase the pressure in the chamber and document when the foam collapses and what percentage of foam in the chamber collapses at the documented pressure. Continue to increase the pressure level, documenting all collapses of bubble that are in excess of 10% of the total chamber volume. When the maximum safe pressure is reached on the pressure chamber, document the remaining volume of foam left in the chamber. The weight of the gas contained in the chamber was then calculated.

Calculations were made to show the expected pressures at which the foam vessel or bubble would collapse and are shown in Table 6 below.

TABLE 6
Volumetric Calculations Based on Testing

| | | | | Pressure | | | | | |
|---|---|---|---|---|---|---|---|---|---|
| | | | | in Bottle | 1st | 2nd | 3rd | 4th | |
| | | Compressed | | When full | Bubble | Bubble | Bubble | Bubble | Final |
| | Compressed | Gas | Atmospheric | and valve | Collapse | Collapse | Collapse | Collapse | Pressure |
| Units | Gas(Static) | (Dynamic) | Pressure | is closed | Pressure | Pressure | Pressure | Pressure | on Chamber |
| PSI | 80 | 70 | 14.7 | 11.6 | 30.5 | 34.5 | 38 | 42 | 60 |
| Pa | | | 101325 | 181304 | 311615 | 339194 | 363326 | 390905 | 515011 |
| % of | | | | | 20% | 15% | 15% | 15% | 35% |
| Chamber | | | | | | | | | |

The assumptions listed in Table 7 below were utilized to calculate the weight of carbon dioxide in the foam vessel or bubble.

TABLE 7
Assumptions

| | | |
|---|---|---|
| PSI to PA | 6894.76 | Pa/PSI |
| Air at 1 atm | 101325 | Pa |
| Volume of Chamber | 693.4 | in³ |
| Volume of Chamber | 0.401 | ft³ |
| Volume of Chamber | 0.011 | m³ |
| R - Ideal Gas Constant | 8.3145 | J/mol K |
| n - moles | 28.97 | air |
| Molecular Weight of Air | 28.97 | gm/mol |
| Molecular Weight of CO2 | 44.01 | gm/mol |
| Temp - Kelvin | 293 | K |
| Temp - Celsius | 20 | C. |

Under the Ideal Gas Law:

PV=nRT Eq. 3

n=PV/RT Eq. 4

where P is pressure in Pascals (Pa), V is volume (cubic meters (m³)), n is the amount of gas in moles, R is the Universal Gas constant (J/mol K), T is temperature in Kelvins (K).

Using Eq. 4, the weight of air at (20° C. and 1 atm) can be calculated as follows:

n=PV/RT Eq. 4

n=(101325 Pa*0.0113 m3)/(8.3145 J/mol K*293 K)

n=0.470 moles

Weight of Air=moles*molecular Weight Eq. 5

Weight of Air=13.6 gms

The weight of air in the pressure chamber as validated by bubble collapse requires calculation of n at each bubble collapse pressure using Eq. 4 and is shown in Table 8 below.

TABLE 8
Weight of Air in the Pressure Chamber
as Validated by Bubble Collapse

| | 1st | 2nd | 3rd | 4th | |
|---|---|---|---|---|---|
| | Bubble | Bubble | Bubble | Bubble | Final |
| | Collapse | Collapse | Collapse | Collapse | Pressure |
| Units | Pressure | Pressure | Pressure | Pressure | on Chamber |
| PSI | 30.5 | 34.5 | 38 | 42 | 60 |
| Pa | 311615 | 339194 | 363326 | 390905 | 515011 |
| % of | 20% | 15% | 15% | 15% | 35% |
| Chamber | | | | | |
| n | 1.45 | 1.57 | 1.69 | 1.81 | 2.39 |
| Weight | 8.37 | 6.84 | 7.32 | 7.88 | 24.22 |
| (gm) | | | | | |

The total weight of air inside the foam is the sum of weights at the collapse pressures. The weight of air in the pressure chamber is approximately 54.64 gm. The weight of air at 20° C. and 1 atm (from Above) is 13.6 gm. Therefore, the bubble contains 4.01 times the weight of air.

Due to the fact that carbon dioxide can be considered an ideal gas, particularly at less than 5 atmospheres, the net weight of carbon dioxide can be calculated in the foam by substituting the molecular weight of the carbon dioxide. Therefore, the weight of carbon dioxide is as follows:

$${Weight}_{{CO}_{2}} = \frac{Weight of the Air * Molecular Weight of {CO}_{2}}{Molecular Weight of Air} = 83.0 gm \qquad Eq . 6$$

The weight of carbon dioxide in a cubic foot of foam is:

$${Weight}_{{CO}_{2} f {t}^{3}} = \frac{Weight of {CO}_{2} in chamber * 1 {ft}^{3}}{Volume of the Pressure Chamber} \\ {Weight}_{{CO}_{2} f {t}^{3}} = 0.456 lb . \text{/} {ft}^{3} \qquad Eq . 7$$

### EXAMPLES

The disclosed embodiments may be deployed in any number of means, including the following examples. In these examples, the following definitions and calculations are used.

Conversions

1 yd³=27 ft³

1 MT (metric ton)=2200 lb

Carbon Dioxide Information

Weight_{CO}_{₂}_{STP}=0.123 lb/ft³

STP=0 Celcius and 1 atm

Weight_{Gas Entrained}=0.46 lb/ft³

Cement and Concrete Information

The usage of Portland Cement in the USA in 2013 was 77 Million Metric Tons of cement. A conservative estimate of 50% of the above cement amount is used in infrastructure—roads, highways, bridges, sewers, and hospitals. 1 yd³ of concrete has an average of: 400 lbs. of cement. 1 yd³ of concrete weighs an average of 3800 lbs. Therefore, the volume of concrete used in the USA in 2013 is:

$${V}_{Concrete} = \frac{( 77 , 000 , 000 Tons of cement ) * ( 2200 \frac{lb}{metric} ton )}{400 lb \text{/} {yd}^{3} of concrete} = 423 , 500 , 000 {yd}^{3} \qquad Eq . 8$$

Concrete absorbs between 40-55% of initial carbon dioxide emissions over 100 year life. In 2013, world production of cement was 4080 million Metric Tons.

Gas Entrainment

Use of gas entrainment in concrete is critical for improved durability.

### Example 1

### Carbon Dioxide Disposal in High Strength Applications

In a high strength application, the disclosed embodiments may be deployed in infrastructure, such as roads and bridges. For example, infrastructure mix design criteria typically allows for approximately 6% air/gas entrainment. In an example at 6% gas entrainment in infrastructure where the total concrete used in the USA in 2013 is 494,098,000 yd³ and the concrete used in infrastructure in 2013: 247,049,000 yd³, the total potential weight of carbon dioxide use is:

$${Weight}_{{CO}_{2}} = 247 , 049 , 000 {yd}_{concrete used}^{3} * 6 \% * ( 27 {ft}^{3} \text{/} {yd}^{3} ) * ( 0.46 lb \text{/} {ft}^{3} ) = 184 , 100 , 914.8 lbs \qquad Eq . 9$$

In an example at 9% gas entrainment in infrastructure where the total concrete used in the USA in 2013 is 494,098,000 yd³ and the concrete used in infrastructure in 2013: 247,049,000 yd³, the total potential weight of carbon dioxide use is:

$${Weight}_{{CO}_{2}} = 247 , 049 , 000 {yd}_{concrete used}^{3} * 9 \% * ( 27 {ft}^{3} \text{/} {yd}^{3} ) * ( 0.46 lb \text{/} {ft}^{3} ) = 276 , 151 , 372.2 lbs \qquad Eq . 10$$

### Example 2

### High Volume Applications

Flowable Fill/Soil Stabilization, Fire Retardant and Insulating applications are currently utilized in areas such as high risk chemical plants. The use of foamed cement to cover building structural beams where very low thermal conductivity is a must, lends to concrete with low compressive strength (e.g. 3,000+ psi) and a great volume of air/gas for insulation properties. In a job size of 18,000 yd³ of flowable fill concrete at 40% gas entrainment, the amount of carbon dioxide used is:

$${CO}_{{2}_{Used}} = 18000 {yd}^{3} * 35 \% * 27 {ft}^{3} \text{/} {yd}^{3} = 170100 {ft}^{3} of {CO}_{2} \qquad Eq . 11$$

The weight of carbon dioxide if used in this job would be:

$${Weight}_{{CO}_{2}} = 170100 * 0.46 lb \text{/} {ft}^{3} = 78246 lb of {CO}_{2} \qquad Eq . 12$$

### Example 3

### Beam Fireproofing

Referring to FIG. 15 utilizing the disclosed embodiments, insulated beam 1500 includes beam 1501 surrounded by concrete 1502. In this example, concrete 1502 has a gas entrainment level of 40% by volume and yields the following amount of disposed carbon dioxide. In this example for fireproofing beam 1501 with concrete 1502 with 35% gas entrainment, beam 1501 is a 20 foot long American wide flange steel beam with a cross-sectional area of 18.3 in² and concrete 1502 is applied having a thickness of 4 inches. The amount of carbon dioxide in concrete 1502 is calculated as follows:

$${V}_{Concrete} = [ ( 16.24 * 29 ) - ( 2 * ( 12.2 * 4 ) ) - 18.3 ] * 240 = 85214.4 {in}^{3} = 49.3 {ft}^{3} concrete . \qquad Eq . 13$$

At 35% gas entrainment, the volume of carbon dioxide is:

$${V}_{{CO}_{2}} = 49.3 * 35 \% = 17.3 {ft}^{3} of {CO}_{2} . \qquad Eq . 14$$

The weight of carbon dioxide per beam is:

$${Weight}_{{CO}_{{2}_{Beam}}} = 34.5 {ft}^{3} * 0.46 lb \text{/} {ft}^{3} = 9.9 lbs . \qquad Eq . 15$$

### Example 4

### Carbon Dioxide Disposal Estimates

According to the PCA, the percentage of total cement usage in the United States is listed in Table 9 below.

TABLE 9
Estimates for Cement Yielding Potential
CO₂ Consumption for the USA

| | Percentage of | |
|---|---|---|
| | Total Cement | |
| | used in the | |
| Volume | USA | |
| 157,796,100 | 50% | Infrastructure, 400 lb./yd³ @6% |
| 71,008,245 | 15% | Potential Infrastructure at 9% |
| 94,677,660 | 15% | Unregulated, agriculture, sewage - |
| | | 12% gas entrainment |
| 57,708,288 | 12% | Residential, nonstructural, 350 lb./yd³ 8% |
| 92,047,725 | 5% | CLSM, Nonstructural, flowable fill, |
| | | shotcrete and other lightweight |
| | | applications - 35% |
| 55,228,635 | 3% | Nonstructural, decorative, insulative -35% |
| 528,466,653 | lb. | 0.53 billion lb. total potential CO₂ |
| | | consumption for USA |

The above estimates translate to 159 million yd³ potential carbon dioxide consumption for United States. This would fill a 6 inch diameter pipeline around the world 167 times. This translates to: 4.2 billion ft3 of carbon dioxide consumption, which would fill 243 billion—½ liter bottles of water, five times the number consumed in the USA per year, 45,278 Tons of carbon dioxide consumption, which would cover 276 football fields ten feet deep.

Worldwide, the total cement usage is 4080 million metric tons. The total cement usage in the USA is 77 million metric tons. Utilization of the disclosed embodiments worldwide would have 53 times the impact on carbon dioxide being disposed of. At these rates, at 6% gas entrainment, 227 billion ft³ or 14 million tons of carbon dioxide is disposed.

It will be appreciated by those skilled in the art that modifications can be made to the embodiments disclosed and remain within the inventive concept. Therefore, this invention is not limited to the specific embodiments disclosed, but is intended to cover changes within the scope and spirit of the claims.

1. A system for disposing carbon dioxide, comprising:
a foam generator;
a carbon dioxide source connected to the foam generator, supplying carbon dioxide to the foam generator;
a water source connected to the foam generator, supplying water to the foam generator;
a gas entrainment solution source connected to the foam generator, supplying a gas entrainment solution to the foam generator; and,
a set of disposable foam vessels generated from the carbon dioxide, the water, and the gas entrainment solution.

2. The system of claim 1, wherein the carbon dioxide has a gas pressure range from approximately 60 pounds per square inch to approximately 150 pounds per square inch.

3. The system of claim 1, wherein the carbon dioxide has a gas flow rate range from approximately 2 cubic feet per minute to approximately 50 cubic feet per minute.

4. The system of claim 1, wherein the water has a water temperature range from approximately 35 degrees Fahrenheit to approximately 100 degrees Fahrenheit.

5. The system of claim 1, wherein the water has a water flow rate range from approximately 0.02 gallons per minute to approximately 10 gallons per minute.

6. The system of claim 1, wherein the gas entrainment solution has a solution flow rate range from approximately 0.02 gallons per minute to approximately 10 gallons per minute.

7. The system of claim 1, wherein the gas entrainment solution is a polymer based solution.

8. The system of claim 1, wherein the gas entrainment solution, by weight, comprises:
approximately 96.8% to approximately 82.0% of water;
approximately 0.04% to approximately 3.0% of n-dodecyl-b-iminodipropionic acid;
approximately 0.08% to approximately 5.0% of n,n-bis(2-hydroxyethyl) dodecanamide; and,
approximately 2.0% to approximately 10.0% of an oligomer of ethelene oxide.

9. A medium for disposing carbon dioxide, comprising:
a cementitious mixture comprising:
from approximately 2% by volume of the cementitious mixture to approximately 80% by volume of the cementitious mixture of a plurality of disposable foam vessels, comprising:
water;
a gas entrainment solution; and,
carbon dioxide.

10. The medium of claim 9, wherein the cementitious mixture is a concrete mixture.

11. The medium of claim 10, wherein the concrete mixture further comprises:
Portland cement;
water;
aggregate; and,
sand.

12. The medium of claim 10, wherein the concrete mixture further comprises a high range water reducer.

13. The medium of claim 9, wherein the gas entrainment solution, by weight, comprises:
approximately 96.8% to approximately 82.0% of water;
approximately 0.04% to approximately 3.0% of n-dodecyl-b-iminodipropionic acid;
approximately 0.08% to approximately 5.0% of n,n-bis(2-hydroxyethyl) dodecanamide; and,
approximately 2.0% to approximately 10.0% of an oligomer of ethylene oxide.

14. A method for disposing carbon dioxide comprising the steps of:
providing carbon dioxide at a predetermined gas pressure and a predetermined gas flow rate;
providing water at a predetermined water temperature and a predetermined water flow rate;
providing a gas entrainment solution at a predetermined solution flow rate;
generating a plurality of disposable foam vessels from the carbon dioxide, the water, and the gas entrainment solution;
mixing the plurality of disposable foam vessels with a cementitious material to generate a cementitious mixture; and,
dissipating the plurality of disposable foam vessels in the cementitious mixture.

15. The method of claim 14, wherein the step of providing a gas entrainment solution at a predetermined solution flow rate further comprises the step of providing a polymer based solution as the gas entrainment solution.

16. The method of claim 14, wherein the step of providing a gas entrainment solution at a predetermined solution flow rate further comprises the steps of:
providing from approximately 96.8% to approximately 82.0% of water for the gas entrainment solution;
providing from approximately 0.04% to approximately 3.0% of n-dodecyl-b-iminodipropionic acid for the gas entrainment solution;
providing from approximately 0.08% to approximately 5.0% of n,n-bis(2-hydroxyethyl) dodecanamide for the gas entrainment solution; and,
providing from approximately 2.0% to approximately 10.0% of an oligomer of ethylene oxide of an oligomer of ethelene oxide for the gas entrainment solution.

17. The method of claim 14, wherein the step of mixing the plurality of disposable foam vessels with a cementitious material to generate a cementitious mixture further comprises the steps of:
providing Portland cement for the cementitious mixture;
providing water for the cementitious mixture;
providing aggregate for the cementitious mixture; and,
providing sand for the cementitious mixture.
